(19) United States
(12) Patent Application Publication
(10) Pub. No.: US 2009/0289896 A1
(43) Pub. Date: Nov. 26, 2009

(54) INPUT ARRANGEMENT FOR ELECTRONIC DEVICES

(76) Inventor: Emil Jacob, Cambridge, MA (US)

Correspondence Address: JOHN BROOKS LAW LLC, P.O. Box 156, WRENTHAM, MA, 02093, US

(21) Appl. No.: 12/535,090

(22) Filed: Aug. 4, 2009

Related U.S. Application Data
(63) Continuation-in-part of application No. 11/702,945, filed on Feb. 5, 2007.
(60) Provisional application No. 60/776,223, filed on Feb. 24, 2006.

(51) Int. Cl. G06F 3/033

(52) U.S. Cl. 345/158; 345/163

(57) ABSTRACT

A new form of input arrangement for cursor control devices or other handheld electronic devices in which the activation surfaces are designed to allow the fingers and thumb of the user to affect commands by means of ergonomic and less repetitive motion as compared to current devices. In embodiments, sensors are associated with the user's digits which sense motion in not only the downward direction, but in multiple directions. In embodiments, the cursor control device has resilient pads to further add comfort to a user. The resulting ability of the user to vary and reduce the points of pressure and other stresses onto different surfaces of the digits and corresponding nerves and muscles serves to reduce discomfort and pain resulting from current devices.

### CROSS-REFERENCE TO RELATED PATENT APPLICATIONS

This application is a continuation in part of co-pending U.S. patent application Ser. No. 11/702,945, filed 5 Feb. 2007, entitled “Input Arrangements for Electronic Devices” the entire contents of which are herein incorporated by reference in their entirety. This application also claims benefit of U.S. Provisional Patent Application Ser. No. 60/776,223, filed 3 Feb. 2006, entitled “Ergonomic Electronic Devices” the entire contents of which are incorporated by reference in their entirety.

### STATEMENT REGARDING FEDERALLY SPONSORED RESEARCH OR DEVELOPMENT

Not Applicable.

### NAMES OF PARTIES TO JOINT RESEARCH AGREEMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Current input devices designed for use with computers, commonly referred to as mice, are increasingly used to carry out commands in using the most modern operating system software and applications. Most such devices require repetitive use of the same finger or thumb of the user and the same motion to produce particular commands to the computer. This need for using the same physical motion, and only that motion, to generate the same command results in muscle, joint and nerve damage to the user, such as carpal tunnel syndrome, among other conditions.

The above situation is aggravated in cases where the command in question is a dominant or highly utilized one for the operation of the computer. For example, in using a typical mouse or cursor control, the left click command is one such a command. It is used more than any other and results in the aforementioned physical damage to the user. A solution to this problem which could easily be incorporated into a otherwise standard cursor control would be highly desirable.

It is believed that much of the above noted physical damage to the user could be avoided by changing and distributing the pressure and stresses attendant to the inputting of commands from a computer mouse or other like input device, such a keyboard. This is accomplished in the invention by the use of a motion sensing arrangement in the device which allows the user to effect commands, or at least the most repeated commands, through a variety of different commands a variety of different motions, rather than through a single, unvarying motion. Alternatively, the repetitive command is accomplished by means of an input arrangement which permits different digits of the hand to effect the same command, to thereby provide a way to distribute the stresses normally borne by any single digit. By permitting the user to utilize not only downward motion (almost universally used in current devices) but also back and forth and sideways motions of the digits, physical stresses are distributed in a way that eliminates the bad effects of current constructions. Alternatively, by providing alternate input keys located on the input device to allow activation by different digits the same beneficial result may be achieved.

It is universal practice for users of certain cell phoned devices (Blackberry style devices) to input data into these cell phones by using a two handed technique for entering data in which both hands are used to hold the phone while concurrently using both thumbs to enter data. The above method is initially comfortable for the user and increases the efficiency of data entry into the device. However, this technique is associated with significant stress to the thumbs, resulting in damage to nerves and muscles and is the source of great discomfort to many users. By alleviating the need for using exclusively the thumb input technique, such damage may be prevented.

In many electronic devices the fingers and thumbs must be moved large distances to carry out commands on input devices such as computer mice, keyboards and cell phones. By using a key construction according to the invention, a significant lessening of such moves may be accomplished by the use of a data/command input arrangement in which the sensor devices associated with the keys are operative to generate different commands or data entries in response to small movement of the fingers or thumbs in different directions. Thus, relatively small motions in different directions allow the digits to input different commands in a highly efficient manner.

### BRIEF SUMMARY OF THE INVENTION

This invention is therefore directed to a class of new ergonomic electronic input arrangements for handheld electronic devices which reduce the stress associated with repeated movement and increase input efficiency. Included are input arrangements for a computer mouse, and for various handheld electronic keyboard devices, such as cell phones and other portable data entry devices.

There is described a new form of computer cursor control device in which the activation surfaces are designed to allow the fingers and thumb of the user to effect commands by means of non-repetitive motion as compared to current devices. Specifically, sensors are associated with the fingers and thumb which sense motion in not only the downward direction, as generally used in current devices, but also in forward backward and side directions to carry out the same command. The resulting ability of the user to vary the points of pressure and other stresses onto different surfaces of the digits and corresponding nerves and muscles serves to relieve discomfort and pain.

The handheld keyboard input arrangement similarly to alleviates (in a Blackberry-like device, for example) overuse and damage to the thumbs and associated nerves and muscles. This arrangement includes provision of input keys or an entire keyboard on the back of the device so that both the thumbs and fingers may be utilized in entering data. This arrangement may incorporate the same type of individual key input for each finger as was disclosed above for use in the mouse/cursor control. The essence of such an arrangement includes the provision of positioning input sensors or switches in such a way relative to each finger and thumb that several keys may be activated by movement of the finger in various directions. This allows for different motions of the digits of a user to effect a common input or command to thereby distribute the stress attendant to executing an input/command over different digits or the same digit in a different way. Alternatively, by permitting small but differently directed motions to be detected from a single digit, the arrangement enhances the efficiency for entering commands and data in a hand held electronic device.

### BRIEF DESCRIPTION OF THE SEVERAL VIEWS OF THE DRAWINGS

The invention can be best understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a top perspective view of a computer mouse according to the invention showing the hand of a user in the operating position for using the mouse.

FIG. 2 is a view of the mouse of the invention omitting the top wall of the housing to illustrate the details of a sensor arrangement and cursor control used with the new mouse construction.

FIG. 3 is an illustrative perspective view of an alternative construction for the mouse according to the invention that employs a standard mouse and add-on pads to convert different motions of a user's finger into the normal downward motion of a sensing surface.

FIG. 4 is a front perspective view of a representative hand held electronic device incorporating an input key arrangement according to the invention on the rear wall of the device.

FIG. 5 is a view of the back or rear side of the hand held electronic device of FIG. 4 showing an input key arrangement according to the invention with a user's hand shown in dotted lines holding the device and positioned to operate the new input arrangement.

FIG. 6 is a side elevation view of the electronic device of FIG. 4 and showing additional of the rear-wall-located input arrangement.

FIG. 7 is sectional view along the lines 7-7 in FIG. 5 showing the details of the momentary contact switches that make up the input arrangement located on the rear wall of the device.

FIG. 8 is a sectional view of one embodiment of a mouse with built-in pads showing ergonomic design of the pad accommodating the natural form of the index finger.

FIG. 9 is a sectional view of one embodiment of the mouse with added, aftermarket pads, showing ergonomic design of the pad accommodating the natural form of the index finger.

FIG. 10 is a side perspective view of FIG. 8 showing the principles of FIG. 8 applied to the second finger and to the thumb.

FIG. 11 is a side perspective showing one embodiment of the mouse without the hand on it.

FIG. 12 is a representation with dotted line on FIG. 11 showing the area of contact between fingers and mouse.

FIG. 13 is an illustration of one embodiment of a generic computer mouse showing the current problem for a user of an existing computer mouse, with dotted line representing the straight fingers versus the curved in finger in FIG. 8.

### DETAILED DESCRIPTION OF THE INVENTION

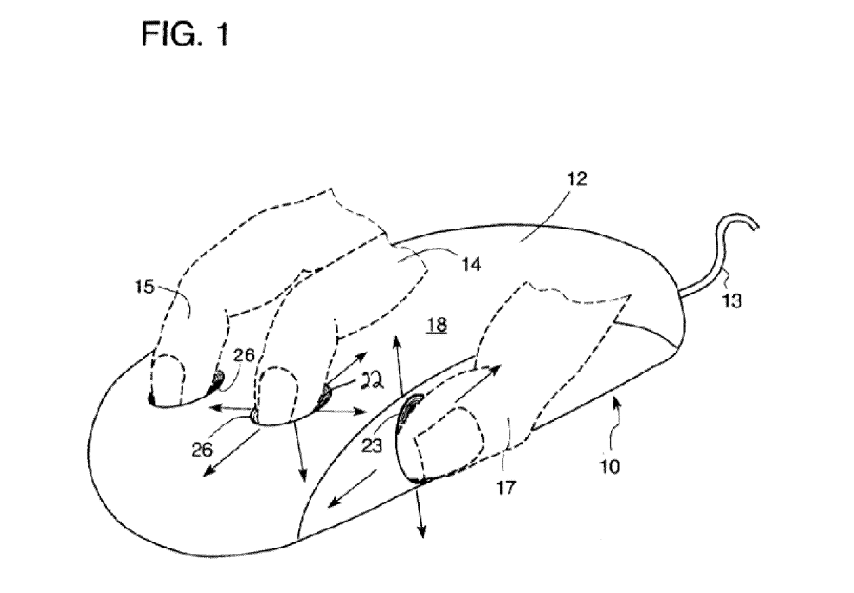

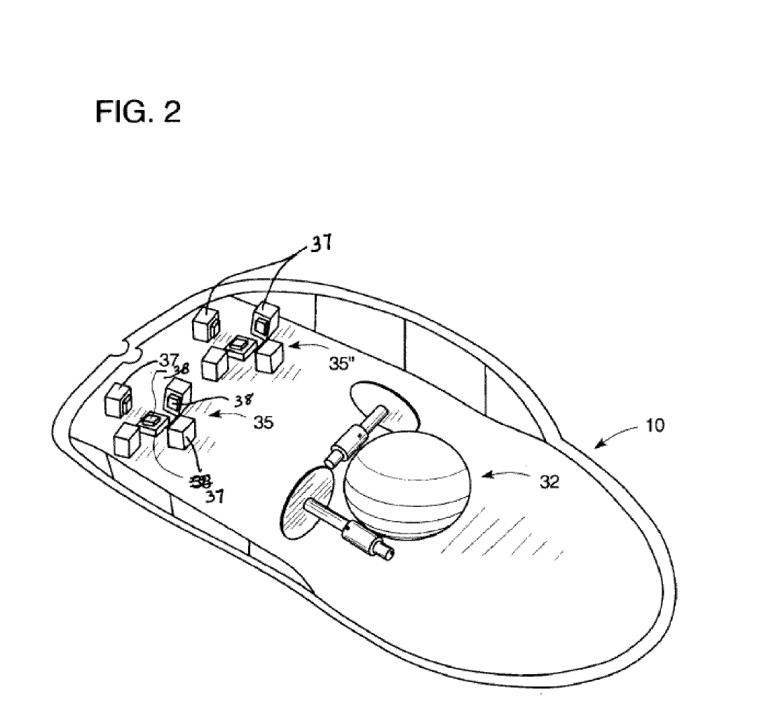

The new ergonomic input arrangements of this invention will now be described in detail with reference to the drawings. The computer cursor control of the invention, as implemented in a generally off-the-shelf mouse, is best understood by reference to FIGS. 1 and 2. Referring to FIG. 1, there is shown a mouse 10 having a housing 12 and a cable 13 for coupling the mouse to a computer (not shown). The mouse 10 is designed for operation by the hand of a user, shown in dotted lines in FIG. 1, including index finger 14, middle finger 15 and thumb 17. The housing 12 includes a generally ovulate-shaped top surface 18 on which the palm of the user rests during operation of the mouse. The surface 18 includes suitably shaped elongated openings 21, 22 into which the tips of the user's fingers extend, and a similar opening 23 in the side wall of the housing into which the tip of the user's thumb 17 extends. The fingers 14 and 15 are located directly above sensor arrangements 35, each of which comprises a plurality of sensor switches 37 oriented with respect to its associated finger to sense movement of the fingers in any one of several directions. The sensor arrangements are physically separated from their associated fingers by any suitably shaped flexible, resilient, half ovulate shaped, insulating material 26, such as rubber, polyurethane etc. The sensor switches 37, FIG. 2, are of the momentary contact type and comprise a first switch contact 38 mounted on an insulating base attached to the floor of the housing and a second contact (not shown) carried on the inside of the insulting material 26 and normally spaced from the contact 37. A switch 37 is activated in response to the movement of its associated finger 14, 15. As can be appreciated, the switches 37 are activated/closed by the movement of the tip of its associated digit in a direction generally toward the stationary contact 38. As a result of this movement the movable contact carried on the material 26 is brought into momentary contact with its corresponding stationary contact 38 and then separated again by movement of the digit away from the stationary contact. Switch arrangements 35 also include similarly constructed switches (not numbered) which are oriented for activation in response to sideways and back and forth motion of the finger. Thus, each of the switch arrangements 35 associated with the fingers 14 and 15 operates in conjunction with a standard electrical circuit connected thereto (not shown) to generate a signal upon the downward, sideways and back/forth motion of its associated finger. A generally similar construction is described hereinafter with respect to FIG. 7, and may also be used in the switch arrangement of FIG. 2.

As is well known, the mouse also includes a signal generator 32 of standard construction that develops a signal as a function of the movement of the mouse over a planar reference surface, not shown. The combination of the signal generated by generator 32 and the closing of a specific switch contact uniquely defines the position of a cursor on the display and thereby selects a command from the display screen of the computer system.

In operation, the user rests his palm on the mouse 10 in the usual manner. He inserts his fingers 14, 15 into the openings 22 and rests them centrally within the insulating material 26, being careful not to unintentionally activate any of the associated switches 37. The user then moves the mouse along the reference surface to generate corresponding movement of a cursor on the display screen of the computer in the usual manner. A standard mechanical tracking system 32 is used for generating a signal corresponding to the position of the moving mouse on the reference surface, it being understood the electrical and mechanical tracking systems used in mice are well known and therefore no attempt to describe them in detail is provided. Likewise, it is equally possible to employ a more modern optical tracking arrangement for this purpose, also well known in the art. In addition, the cable 13 could be replaced by an optical or radio frequency coupling system between the mouse and the computer.

If a left click of the mouse is required to send the appropriate command, the user has the choice of employing downward, forward, backward, or side movements to effectuate the activation of an associated switch. This permits the user to distribute the cumulative stress and pressure resulting from left click switch activation over different surfaces of the index finger and likewise, to possibly involve different muscles and nerves in such movements. The result is a decreased likelihood of physical damage to the user because of the high number of repetitive activations required by modern graphical user interface software.

In a similar fashion, the thumb 17 may have associated therewith a similarly constructed and arranged sensor arrangement, not shown. While two finger activation openings 22 are shown in the drawings, additional ones may be added in a similar fashion.

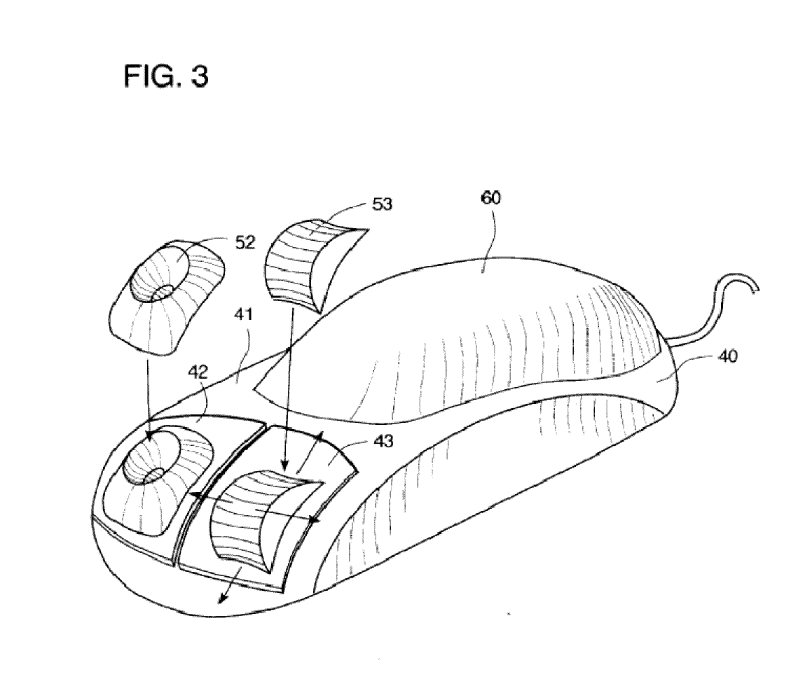

Referring now to FIG. 3, there is shown an alternative way of achieving a similar result as discussed above without the need for a modified mouse and sensor arrangement by the addition of special activation pads to a standard mouse. A standard mouse 40 is shown having the typical construction in which both right and left clicks are carried out by means of a slight downward movement of the surfaces 42 and 43 with respect to the top surface of the housing 41. The surfaces 42 and 43 are, of course, moved by means of fingers (not shown) of a user's hand. By attaching properly shaped soft, flexible and resilient pads 52 and 53, to the activation surfaces 42 and 43, the activating finger is able to generate the needed downward force on these surfaces by motion in the forward, backward or sideways directions similar to what is accomplished with the arrangement of FIGS. 1 and 2. The material for the pads would be chosen from a variety of plastic, rubber or foam products that are soft relative to the hard plastic surfaces 42, 43. The pads may be shaped in any manner to best produce the end result of translating the various aforementioned motions of the fingers/thumb into a suitable downward/sideways force of sufficient strength to activate the switch associated with the surfaces 42, 43. For this purpose, the shape of pad 53 has been found to be suitable. The shape of the pad 52 which has a generally concave upper surface with relatively deep and steep inner walls, would be even more effective for this purpose. As opposed to the need to exclusively use the normal downward motion to issue commands with such mice, the pads 52, 53 permit the user instead to move the finger backward, for example, to thereby decrease the number of repetitive downward movements. An additional advantage would be to allow the user to vary the point of contact of the finger/thumb with the pad (as compared to constant and repetitive downward motion). In the FIG. 3 arrangement, a pad 60 may be used to elevate the user's palm to more comfortably operate the mouse when pads 52, 53 are employed.

All of the pads 52, 53 and 60 would be sold as an aftermarket accessory kit for use with conventional mice to avoid or alleviate the physical damage and pain associated with the use of repetitive finger/thumb movements. Each pad would have an adhesive coated bottom surface covered with the usual removable/releasable sheet, as conventionally provided in similar products.

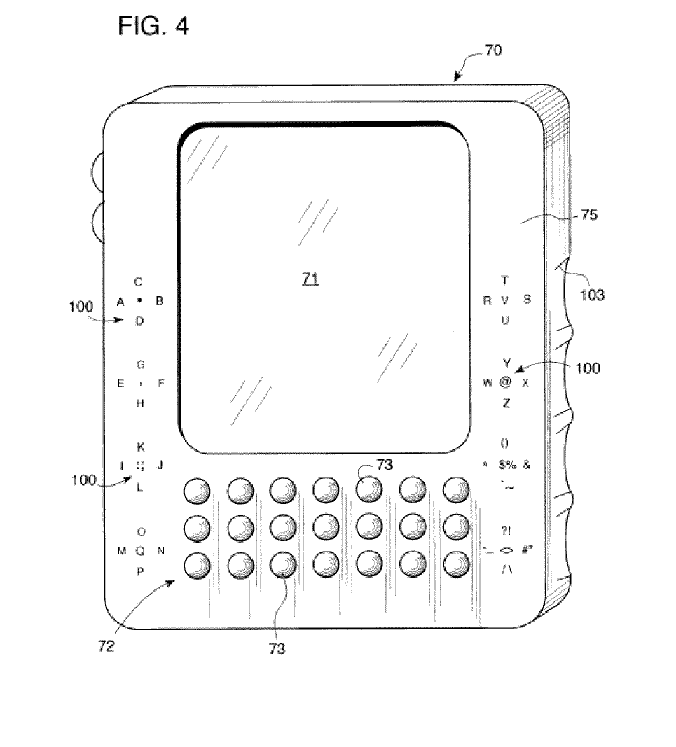

Referring to FIG. 4, the portable electronic device 70 includes a front wall 75 supporting an electronic display screen 71 and an input keyboard 72 comprising a standard set of keys 73. Since the invention does not reside in the details of construction of the keyboard, the number of keys, their placement on the keyboard and their construction are not essential parts of this invention.

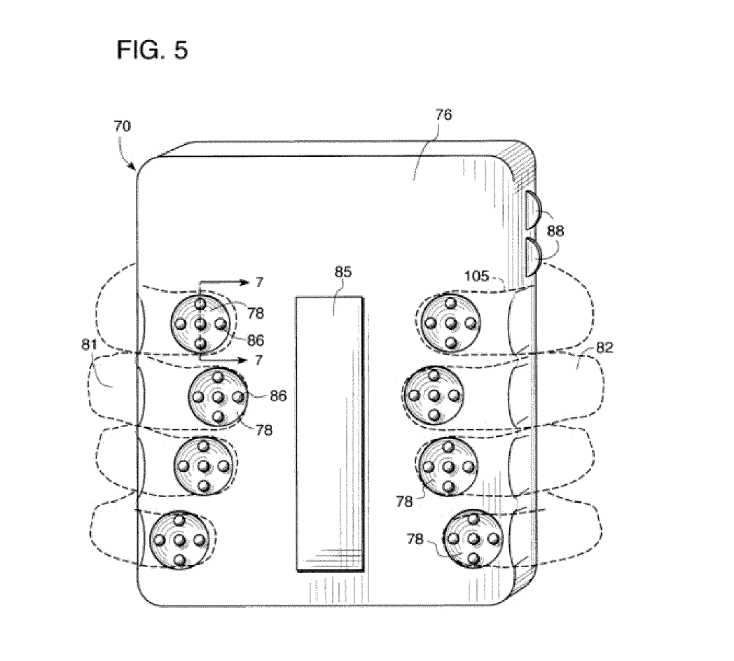

The electronic device 70 is shown from the rear in FIG. 5 to include a rear wall 76 supporting thereon four finger input key arrangements or pods 78 located along each side of the rear wall. The right 81 and left 82 hands of user of the device are shown in dotted lines in their intended operative position. The device 70 represents one of the many portable handheld devices referred to hereinbefore and for which the typical technique for entering data into the device is to support it between the palms of both hands with the fingers behind and the thumbs in front of the device. In this position, the thumbs have access to the front keypad 72 and are used to enter commands and data. The fingers of both hands, in prior are devices, are typically relegated to aiding in the holding process, according to the unique style and habits of the individual user.

In the input arrangement according to the invention, the fingers of both of the user's hands are located to operate the input pods 78, as shown in FIG. 5. The pods 78 on the rear wall are located to extend along each of the sides of the rear wall to approximate the positions of the corresponding fingers along this dimension, with the distance of the pods from the mid-line of the unit varying somewhat according to the relative lengths of the each of the associated fingers.

The rear wall 76 of the device 70 also includes a cursor control pad 85 analogous to and constructed in the same way as the electrostatic finger pads commonly found on modern laptop computers. The pad 85 is operated by the middle or index finger when needed to move the cursor on the front display screen and select commands for input to the system in the usual manner. Since the essence of the invention resides in the placement of the input controls rather than the particulars of their construction, no details of the standard pad 85 construction are provided for this commonly employed input device.

Each finger of both hands has a pod 78 with which it is associated. For this purpose, the hard insulating plastic of the rear wall 76 is formed into a series of concave recesses or wells 78. The floor of each recess has deposited thereon a total of five fixed contacts 83, one in the center and the others spaced at 90 degree intervals on an off-center circumference of the recess 78 on the interior wall thereof. Over each fixed contact 83 is supported a movable contact 84 normally displaced from the fixed contact but supported juxtaposed thereto by a flexible dome shaped activation button 86 and a flexible contact support dome 89. In normal operation, each finger is placed in an associated recess, as shown, and positioned to operate any one of the five buttons to flex the button 86 and support material 89 to bring the moveable contact 84 momentarily into contact with the fixed contact 83. It should be noted again that the pods 78 may be constructed in any number of ways known in the art to accomplish the desired operation as shown and no claim to novelty of the specific switch/pod construction is intended hereby.

In order to guide the user to effect the appropriate data or command input to the system there are provided on the front wall of the device 70 a plurality of mapping guides 100 list the data and/or commands associated with each finger and the proper button to depress in order to input any specific data or command. The number of pods 78 is entirely at the discretion of the designer to decide. Using only one or a few keys on the rear wall, for example, greatly increases the efficiency of data entry. If the shift key is employed on the rear wall and after the user learns its position, the user would not need to look down at the front keyboard to input shift combination data, such as capital letters, etc. In addition, sharing the input of common data between the thumbs via the front keypad and a finger via the rear pod(s) would decrease the normal stress attendant to using the same digit all the time.

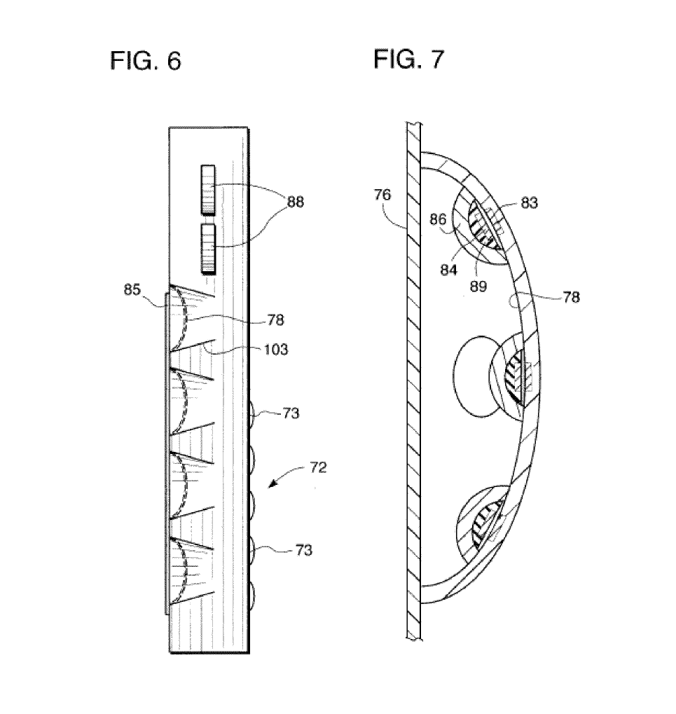

To summarize, as shown in FIGS. 4-7, another aspect of the invention is a handheld electronic device in which physical damage to the thumbs of a user is alleviated by the provision of keypads on the back wall of the unit accessible to the user's fingers for operation thereby. With this construction, each finger remains in a relatively fixed position at which the finger operates five button switches to enter data. Each finger has the ability to activate several adjacent button switches by means of relatively small discrete finger movements in different directions, as shown in the figures. This arrangement eliminates the relatively large movement of the fingers in search of the correct key normally required by other input devices currently on the market. The arrangement also provides an increased efficiency for data input as compared to the current method of hunting and pecking with the thumbs or index finger.

An additional advantage of this arrangement is that the fingers, by being made accessible to keys on the rear of the device, provide an alternative to activation of one or all of the input keys more typically operated by the thumbs on the front of the device. By having an alternative input, the normal physical stresses felt by the thumb are alleviated, as compared to exclusively needing to use the thumbs for data/command inputs as described hereinbefore. While a more standard key construction may be employed for these rear keys as compared to the multiple input per finger arrangement as shown, the construction according to FIGS. 4-7 above may be employed. Single or multiple inputs may be associated with each finger in any of the arrangements for maximum efficiency of the device. One or all or in between data and commands may be entered through both or one of the two keypads.

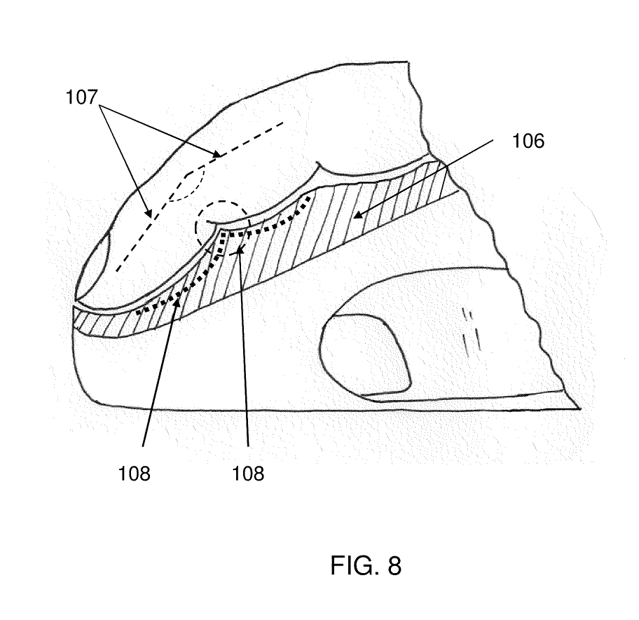

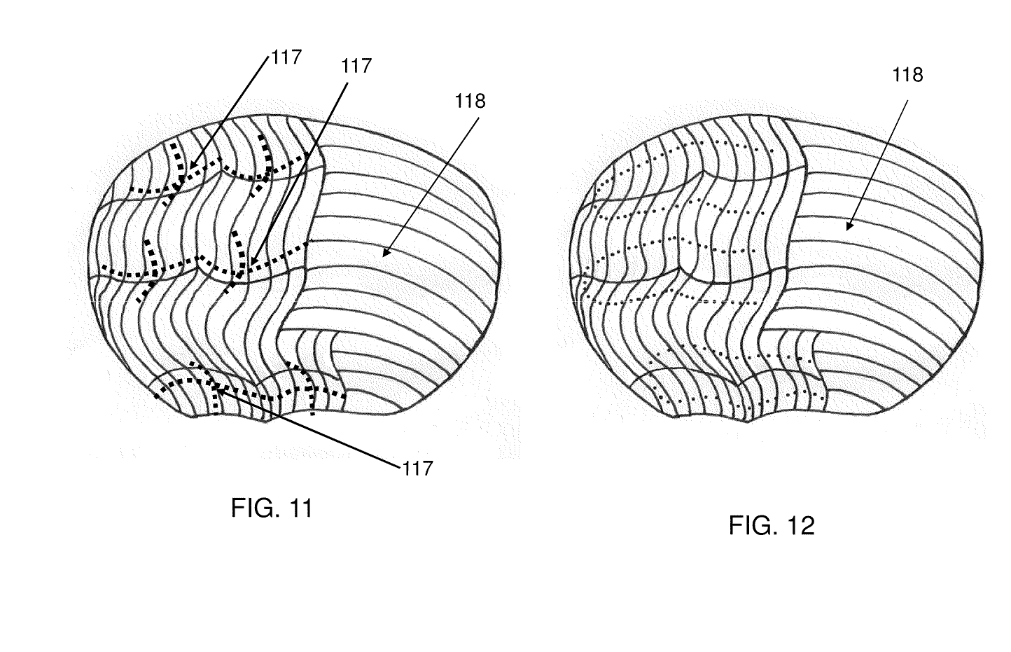

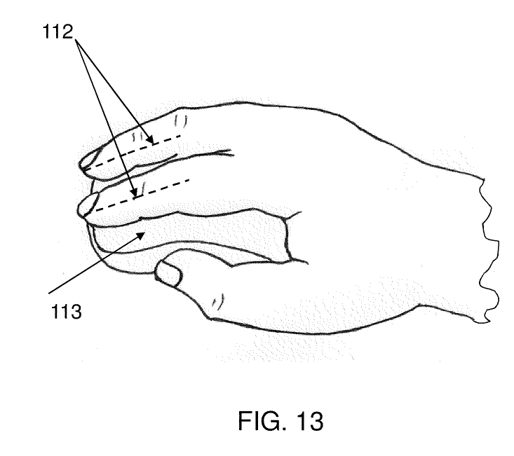

One of the discomforts faced by the users of pointer controls, such as a computer mouse, is the hard plastic material on which the user is required to press, FIG. 13 surface 113. Embodiments of this disclosure provide a solution, as shown in FIG. 8, whereby a pointer control contains a built-in padded resilient surface 106, such as but not limited to a soft gel, which provides a softer surface for the fingers to press on. It is understood that embodiments of a pointer control device having a resilient pad may comprise resilient pads that act as the only interface between the user and the sensing mechanisms or the resilient pads may be added to other surfaces that create a combined interface between the user and the device sensing mechanisms. A benefit of some embodiments of the invention, in addition to the softer surface, is the providing of a concave surface contoured into the padding to accommodate the convex shape of the fingers pressing into it. One illustration of this is shown in FIG. 11 where the dotted lines intersect at the deepest/most concave points and in FIG. 12 where the dotted line represents the surface of contact between fingers and the mouse. By changing its shape under pressure the soft padding helps further increase the total area of contact between the fingers and the pointer control thus requiring less force to click. In other words the clicking switch under the padding 106 captures the finger pressure faster.

A second challenge faced by pointer control users is that the fingers remain in a generally straight position rather than bending inwards in a grasping or gripping movement which is more natural for the hand. FIG. 13 shows the current art where the first and second joints (distal and proximal interphalengeal joint respectively) of the fingers are kept in a generally straight line 112.

Referring to FIG. 8, embodiments of the present invention improve the position of the joints by having the padded area 106 contoured according to the human finger when in resting position where the joints form an angle that is less than 180 degrees shown by dotted lines 107. To ensure that the first joint will bend inwards when clicking, there is a protruding tip or protruding ridge 108, on the pad which is designed to mirror the recess caused by the joint of the finger and bring the user to place the first joint on the protruding ridge 108 thus making the clicking more comfortable by causing the bending the finger inwards. The presence of the protruding ridge also increases the surface area of contact between the pad and the finger reducing the stress on the finger. Regardless of the length of the finger or size of the hand the protruding ridge 108 provides an optimal positioning of the first joint.

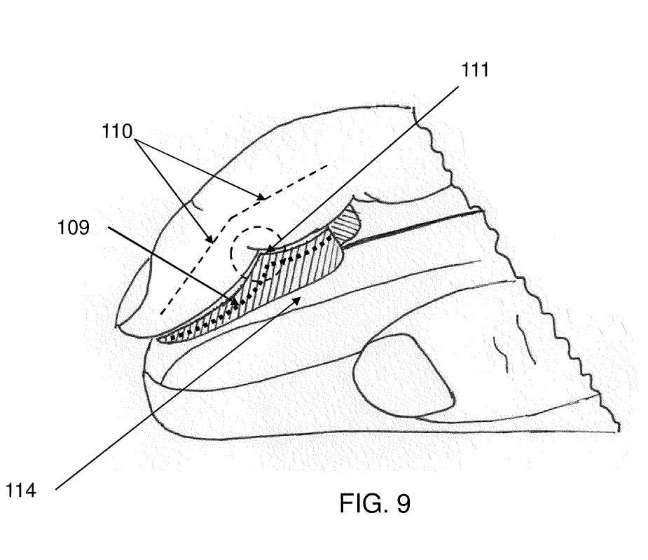

The same features as described above are shown in the aftermarket pads in FIG. 9 which are added to an existing computer mouse. In FIG. 9 dotted line 109 shows the contour of the pads following the human finger and area 111 provides the protruding ridge where the first joint is best positioned when clicking. Dotted lines 110 show the less than 180 degrees angle at which the finger will bend as a result of the pads versus the otherwise flat surface of the mouse 114.

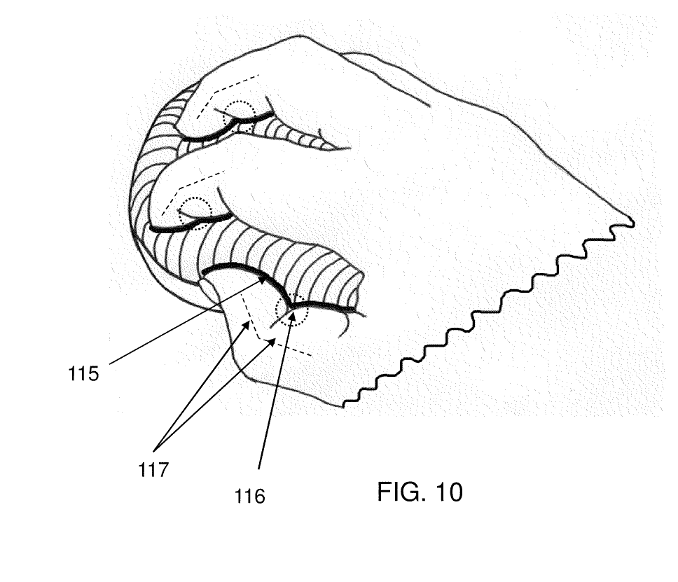

The above description referred so far to the index and the second finger. The same principles of the invention are shown to benefit the thumb in FIG. 10 allowing the option to click with either the index or the thumb. This embodiment is similar to FIG. 1 that shows a mouse where the thumb is provided with a button for left clicking as an alternative or addition to the index finger in order reduce repetitive motion for the index finger—thus In FIG. 10 the clicking area for the thumb shown by thick line 115 and has the same contoured features as described above for the index and second fingers with 116 representing the protruding ridge where the first joint of the thumb is ideally placed in order to cause the thumb to bend into angle 117 when clicking. FIG. 10 also shows the index and the second finger from a rear side view having an ergonomically healthier grasping and gripping position than the current art shown in FIG. 13

FIG. 11 shows the present invention with padded area of a computer mouse where dotted lines intersect at the deepest point in concave areas 117 designed to accommodate the natural, convex shapes of the human fingers.

FIG. 12 shows the contact surface between the fingers and the padded mouse.

FIGS. 11 and 12 also show one embodiment of the pointer control or computer mouse having a resilient palm pad 118 to provide a comfortable surface area for resting the user's palm.

The preceding description has presented in detail exemplary preferred embodiments of the invention and its application. Those skilled in the art will recognize that numerous alternatives encompassing many variations may readily be employed without departing from the scope of the present invention as set forth in the claims herein.

What is claimed is:

1. A pointer control for an electronic device, said pointer control comprising:
at least one sensor responsive to movement by at least one digit of a hand of a user to deliver a signal to an electronic device; and
at least one resilient pad to interface with said digits thereby allowing said user to generate said signals to said electronic device by movement of a digit of said user's hand against said resilient pads.

2. The pointer control of claim 1 further comprising:
at least two motion sensors associated with at least two digits of said hand of said user; and
said sensors responsive to movement by different digits to deliver said signal to said electronic device, to thereby allow said user to generate a repetitive command to said electronic device using different digits and thereby distribute stresses associated with repeated use of a single command over said digits.

3. The pointer control of claim 1 wherein:
said resilient pads comprise material which is resilient relative to a pointer control housing;
said resilient pads shaped to interface between at least some of said digits and said surfaces; and
said pads having a removable sheet which is removable to expose an adhesive coated bottom surface adapted to mount said pad onto said surface.

4. The pointer control of claim 1 wherein said resilient pad has a protruding ridge mirroring a recess in a surface of said at least one digit at an interphalangeal joint, and said ridge being positioned to interface with said surface of said joint causing said joint to bend at an angle less than about 180 degrees when said digit is interfacing with said resilient pad.

5. The pointer control of claim 1 wherein said pad further comprises at least one concave area that accommodates a convex form of said user's digit.

6. The pointer control of claim 1 wherein said electronic device is a computer.

7. The pointer control of claim 1 further comprising a resilient palm pad.

8. A pointer control for an electronic device, said pointer control comprising:
a mouse having a housing;
said housing including a plurality of distinct surfaces for movement by a user to generate inputs to an electronic device by movement of a digit of said user against said surfaces; and
a resilient pad shaped to interface between said digit of said user and said surfaces.

9. The pointer control of claim 8 further wherein said resilient pad further comprises a removable sheet to expose an adhesive coated surface adapted to mount said resilient pad onto said distinct surface.

10. The pointer control of claim 8 wherein said resilient pad further comprise concave areas to accommodate a natural convex surface of a human finger.

11. The pointer control of claim 8 wherein:
said pad includes a protruding ridge that mirrors a recess in a surface of said digit at an interphalangeal joint of said user; and
said ridge being positioned to interface with said surface of said joint causing said joint to bend at an angle less than about 180 degrees when said digit is interfacing with said pad.

12. The pointer control of claim 8 wherein said electronic device is a computer.

13. The pointer control of claim 8 further comprising a resilient palm pad on said housing.
